(19) United States
(12) Patent Application Publication
(10) Pub. No.: US 2025/0324397 A1
(43) Pub. Date: Oct. 16, 2025

(54) PAGING TRANSMISSION METHOD, COMMUNICATION DEVICE AND STORAGE MEDIUM

(71) Applicant: SHENZHEN TRANSSION HOLDINGS CO., LTD., Shenzhen (CN)

(72) Inventor: Sha WANG, Shenzhen (CN)

(73) Assignee: SHENZHEN TRANSSION HOLDINGS CO., LTD., Shenzhen (CN)

(21) Appl. No.: 19/249,180

(22) Filed: Jun. 25, 2025

Related U.S. Application Data
(63) Continuation of application No. PCT/CN2023/070174, filed on Jan. 3, 2023.

(51) Int. Cl. H04W 68/02

(52) U.S. Cl. CPC H04W 68/02

(57) ABSTRACT

A paging transmission method includes selecting or determining a paging frame and/or a paging occasion where the paging is located based on a preset strategy; and receiving the paging according to the paging frame and/or the paging occasion, thereby realizing compact transmission of the paging frame and/or the paging occasion, and reducing the duration of the base station or the cell in the energy-saving state for sending paging during the entire paging cycle, thereby ensuring the sleep duration of the base station or the cell in the energy-saving state.

### CROSS-REFERENCE TO RELATED APPLICATIONS

This application is a continuation application of International Application No. PCT/CN2023/070174, filed on Jan. 3, 2023, the content of which is incorporated herein by reference in its entirety.

### TECHNICAL FIELD

The present application relates to the technical field of communication, and in particular to a paging transmission method, a communication device and a storage medium.

### BACKGROUND

In the current specification, paging occasion (PO) and paging frame (PF) are evenly distributed in an entire paging cycle according to UE ID, which is not conducive to a base station or a cell in the energy-saving state to enter the deep sleep state. Because even if the base station or the cell serves a limited number of terminals, the paging occasion calculated according to the UE ID may occupy PF position in the entire cycle, and then the base station needs to be powered on throughout the paging cycle to provide paging services for limited UEs.

In order to better reduce the duration of the base station or the cell in the energy-saving state for sending paging in the entire paging cycle to ensure the sleep duration of the base station or the cell in the energy-saving state, a compact paging frame/paging occasion mode can be adopted in the paging cycle. However, how to achieve compact transmission of paging frame and/or paging occasion in the paging cycle has not yet been concluded.

Therefore, it is necessary to propose a solution for achieving compact transmission of paging frame and/or paging occasion.

The above description is intended to provide general background information and does not necessarily constitute the related art.

### SUMMARY

The main purpose of the present application is to provide a paging transmission method, a communication device and a storage medium, aiming to achieve compact transmission of paging frame and/or paging occasion.

In order to achieve the above purpose, the present application provides a paging transmission method, which can be applied to a terminal device (such as a mobile phone), including the following steps:
S2: selecting or determining a paging frame and/or a paging occasion for paging based on a preset strategy; and
S3: receiving the paging according to the paging frame and/or the paging occasion.

Optionally, the preset strategy includes at least one of the following: paging configuration information, an energy consumption state and a preset formula.

Optionally, the paging configuration information includes at least one of the following: a default paging cycle, a paging frame offset, a number of first paging frames in the paging cycle, a number of first paging occasions contained in each paging frame, a paging compact cycle and a number of paging frames in the paging compact cycle.

Optionally, the energy consumption state includes a normal transmission state and/or an energy-saving state.

Optionally, the preset formula includes a first preset formula and/or a second preset formula.

Optionally, the first preset formula is configured to determine the paging frame and the paging occasion in the normal transmission state, that is, the legacy paging definition formula.

Optionally, the second preset formula is configured to determine the paging frame and the paging occasion in the energy-saving state, that is, the newly defined paging definition formula.

Optionally, the second preset formula is configured to divide the paging cycle into paging time and non-paging time.

Optionally, the step S2 includes at least one of the following:
in response to that the energy consumption state is the normal transmission state, selecting or determining the paging frame and/or the paging occasion of each paging according to the first preset formula and the paging configuration information; or
in response to that the energy consumption state is the energy-saving state, selecting or determining the paging frame and/or the paging occasion of each paging according to the second preset formula and the paging configuration information.

Optionally, the selecting or determining the paging frame and/or the paging occasion of each paging according to the second preset formula and the paging configuration information includes at least one of the following:
selecting or determining a radio frame where each paging frame is located in the paging cycle according to the second preset formula, wherein the paging frames are continuous in time domain;
selecting or determining the radio frame, the slot or a symbol of each paging occasion in the paging cycle according to the second preset formula, wherein the paging occasions are continuous in time domain; and
selecting or determining the radio frame where each paging frame is located in the paging compact cycle according to the second preset formula, and selecting or determining the slot or the symbol of each paging occasion in the corresponding paging frame.

Optionally, the selecting or determining the radio frame where each paging frame is located in the paging cycle according to the second preset formula includes:
selecting a first radio frame where the paging occasion is located from the paging cycle, and continuously arranging the radio frame where each paging occasion is located based on the first radio frame;
the radio frame, the slot or the symbol where the paging occasion is located are associated with a configuration of a paging search space.

Optionally, the method further includes at least one of the following:
a number of paging occasions contained in each paging frame in the radio frame where each paging frame is located being equal to the number of first paging occasions contained in each paging frame;
a number of paging frames in the radio frame where each paging frame is located being equal to the number of first paging frames in the paging cycle;
a number of paging occasions contained in each radio frame where each paging occasion is located being greater than or equal to the number of first paging occasions contained in each paging frame; and
a number of radio frames in the radio frame where each paging occasion is located being less than or equal to the number of first paging frames in the paging cycle.

The present application further provides a paging transmission method, which can be applied to a network device (such as a base station), including the following steps:
S1: sending paging configuration information to make the terminal select or determine a paging frame and/or a paging occasion where paging is located based on a preset strategy, and receive the paging according to the paging frame and/or the paging occasion.

Optionally, the preset strategy includes at least one of the following: paging configuration information, an energy consumption state and a preset formula.

Optionally, the paging configuration information includes at least one of the following: a default paging cycle, a paging frame offset, a number of first paging frames in a paging cycle, a number of first paging occasions contained in each paging frame, a paging compact cycle and a number of paging frames in a paging compact cycle.

Optionally, the preset formula includes a first preset formula and/or a second preset formula.

Optionally, the first preset formula is configured to determine the paging frame and the paging occasion in the normal transmission state, that is, the legacy paging definition formula.

Optionally, the second preset formula is configured to determine the paging frame and the paging occasion in the energy-saving state, that is, the newly defined paging definition formula.

Optionally, the method further includes: dividing the paging cycle into paging time and non-paging time based on the second preset formula.

Optionally, the method further includes at least one of the following:
the paging compact cycle is smaller than the paging cycle;
the number of paging frames in the paging compact cycle is smaller than or equal to a first number of paging frames in the paging cycle, and the first number of paging frames in the paging cycle is an integer multiple of the number of paging frames in the paging compact cycle;
the second preset formula is configured to divide the paging cycle into paging time and non-paging time;
the second preset formula is configured to select or determine a radio frame where each paging frame is located in the paging cycle, wherein each paging frame is continuous in time domain;
the second preset formula is configured to select or determine the radio frame, the slot or a symbol where each paging occasion is located in the paging cycle, wherein each paging occasion is continuous in time domain; and
the second preset formula is configured to select or determine the radio frame where each paging frame is located in the paging compact cycle, and select or determine the slot or the symbol of each paging occasion in the corresponding paging frame.

The present application further provides a communication device, including: a memory, a processor, and a paging transmission program stored in the memory and executable on the processor, and the paging transmission program implements the steps of any of the above-mentioned paging transmission methods when executed by the processor.

The communication equipment in the present application can be a terminal device (such as a mobile phone) or a network device (such as a base station). The specific reference needs to be clarified in the context.

The present application further provides a storage medium, a computer program is stored on the storage medium, and when the computer program is executed by a processor, the steps of any of the above-mentioned paging transmission methods are implemented.

The technical solution of the present application selects or determines the paging frame and/or the paging occasion where the paging is located based on a preset strategy; and receives the paging according to the paging frame and/or the paging occasion, thereby realizing compact transmission of the paging frame and/or the paging occasion, and reducing the duration of the base station or the cell in the energy-saving state for sending paging during the entire paging cycle, thereby ensuring the sleep duration of the base station or the cell in the energy-saving state.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic structural diagram of a hardware of a mobile terminal for implementing various embodiments of the present application.

FIG. 2 is an architecture diagram of a communication network system according to an embodiment of the present application.

FIG. 3 is a schematic structural diagram of a hardware of a controller 140 according to the present application.

FIG. 4 is a schematic structural diagram of a hardware of a network node 150 according to the present application.

FIG. 5 is a schematic flowchart of a paging transmission method according to a first embodiment.

FIG. 6 is a schematic flowchart of a paging transmission method according to a second embodiment.

FIG. 7 is a schematic diagram of a first principle of a paging transmission method according to the second embodiment.

FIG. 8 is a schematic flowchart of a paging transmission method according to a third embodiment.

FIG. 9 is a schematic diagram of a first principle of a paging transmission method according to the third embodiment.

FIG. 10 is a schematic diagram of a second principle of a paging transmission method according to the third embodiment.

FIG. 11 is a schematic diagram of a third principle of a paging transmission method according to the third embodiment.

FIG. 12 is a schematic flowchart of a paging transmission method according to a fourth embodiment.

FIG. 13 is a first schematic structural diagram of a paging transmission apparatus according to an embodiment of the present application.

FIG. 14 is a second schematic structural diagram of a paging transmission apparatus according to an embodiment of the present application.

FIG. 15 is a schematic structural diagram of a communication device according to an embodiment of the present application.

The realization of the purpose, functional features and advantages of the present application will be further described with reference to the embodiments and the accompanying drawings. Through the above-mentioned drawings, clear embodiments of the present application have been shown, which will be described in more detail below. These drawings and text descriptions are not intended to limit the scope of the present application's concepts in any way, but are intended to illustrate the present application's concepts for those skilled in the art with reference to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S1 and S2 are used for the purpose of expressing the corresponding content more clearly and concisely, and do not constitute a substantive limitation on the order. Those skilled in the art may perform S2 first and then S1 etc. during specific implementation, but these should all be within the protection scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

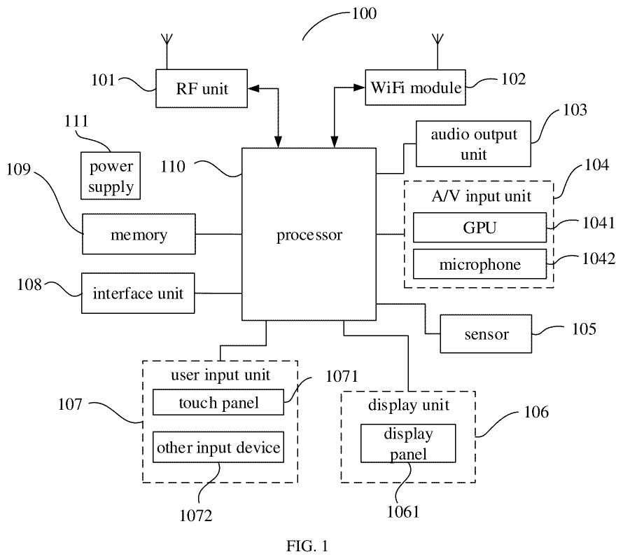

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switching, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and sends it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

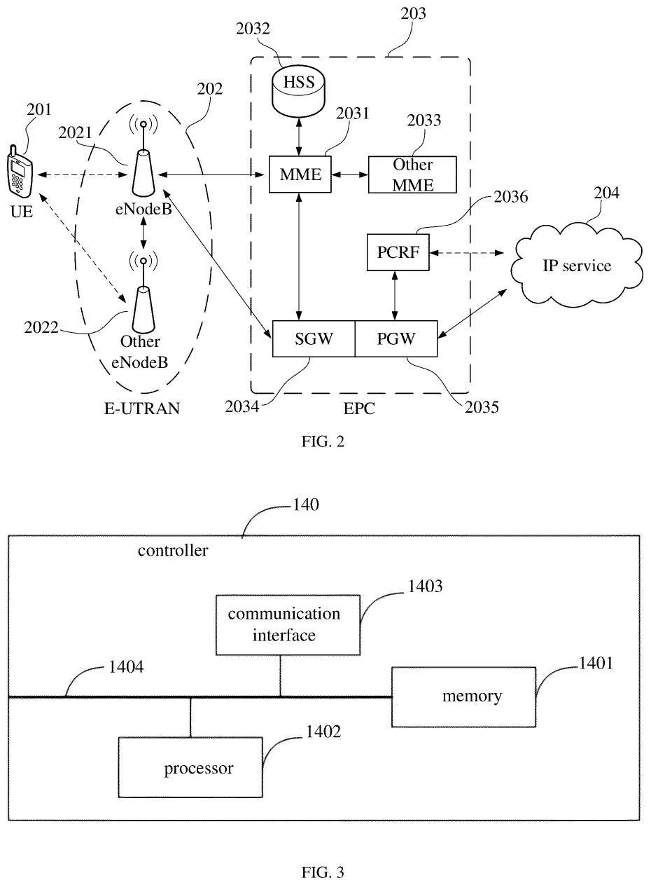

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

FIG. 3 is a schematic structural diagram of a hardware of a controller 140 according to the present application. The controller 140 includes a memory 1401 and a processor 1402. The memory 1401 is configured to store program instructions, and the processor 1402 is configured to call the program instructions stored in the memory 1401 to perform the steps executed by the controller in the first embodiment, and its implementation principle and beneficial effects are similar, which will not be repeated herein.

Optionally, the controller further includes a communication interface 1403, which can be connected to the processor 1402 through a bus 1404. The processor 1402 can control the communication interface 1403 to implement the receiving and sending functions of the controller 140.

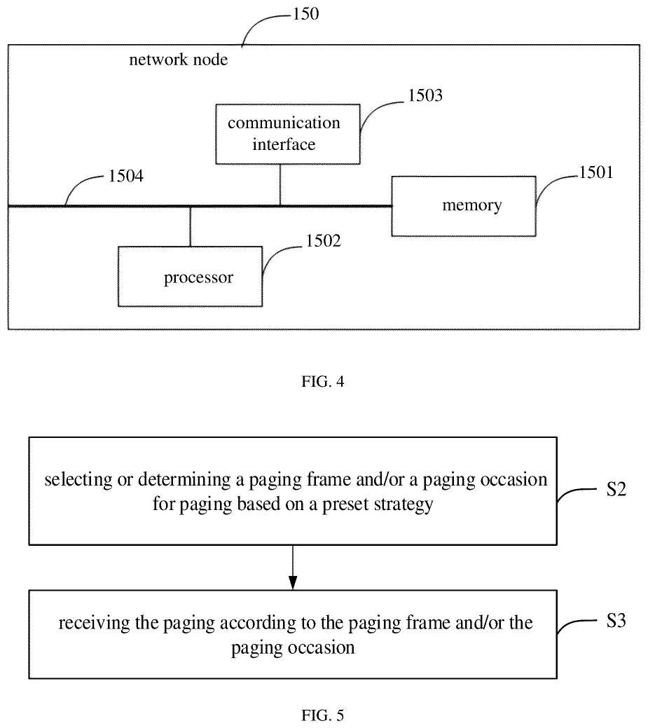

FIG. 4 is a schematic structural diagram of a hardware of a network node 150 according to the present application. The network node 150 includes a memory 1501 and a processor 1502. The memory 1501 is configured to store program instructions, and the processor 1502 is configured to call the program instructions stored in the memory 1501 to perform the steps executed by the first node in the first embodiment, and its implementation principle and beneficial effects are similar, which will not be repeated herein.

Optionally, the controller further includes a communication interface 1503, which can be connected to the processor 1502 via a bus 1504. The processor 1502 can control the communication interface 1503 to implement the receiving and sending functions of the network node 150.

The integrated module implemented in the form of a software function module can be stored in a computer-readable storage medium. The software function module is stored in a storage medium, including several instructions for a computer device (which can be a personal computer, a server, or a network device, etc.) or a processor to perform some steps of the methods of various embodiments of the present application.

In the above embodiments, all or part of the embodiments may be implemented by software, hardware, firmware, or any combination thereof. When implemented by software, all or part of the embodiments may be implemented in the form of a computer program product. The computer program product includes one or more computer instructions. When the computer program instructions are loaded and executed on a computer, the process or function according to the embodiment of the present application is generated in whole or in part. The computer may be a general-purpose computer, a special-purpose computer, a computer network, or other programmable device. Computer instructions can be stored in a storage medium or transmitted from one storage medium to another storage medium. For example, computer instructions can be transmitted from one website, computer, server or data center to another website, computer, server or data center by wired (such as coaxial cable, optical fiber, digital subscriber line (DSL)) or wireless (such as infrared, wireless, microwave, etc.). Storage media can be any available medium that can be accessed by a computer or a data storage device such as a server or data center that includes one or more available media. Available media can be magnetic media (such as floppy disks, hard disks, tapes), optical media (such as DVDs), or semiconductor media (such as solid state disks, SSDs), etc.

Based on the above-mentioned mobile terminal hardware structure and communication network system, various embodiments of the present application are proposed.

### First Embodiment

As shown in FIG. 5, FIG. 5 is a flowchart of a paging transmission method according to a first embodiment. The method of the embodiment of the present application can be applied to a terminal device (such as a mobile phone). The paging transmission method includes the following steps:
S2: selecting or determining a paging frame and/or a paging occasion where the paging is located based on a preset strategy.

In the current specification, the paging frame (PF) and the paging occasion (PO) are evenly distributed in the entire paging cycle according to the UE ID. This method is not conducive to energy saving of base stations in low-traffic scenarios. In the embodiment of the present application, the terminal device can determine the paging frame and/or the paging occasion where the paging is located based on the preset strategy, thereby realizing centralized paging of different terminal devices, thereby leaving a period of time in the paging cycle without paging, so that the base station enters a sleep state and saves energy consumption of the base station.

Optionally, the preset strategy includes at least one of the paging configuration information, the energy consumption state and the preset formula.

Optionally, the paging configuration information includes a default paging cycle, a paging frame offset (PF_offset), the number of first paging frames in the paging cycle (N), the number of first paging occasions contained in each paging frame (Ns), a paging compact cycle (ES duration) and the number of paging frames in the paging compact cycle (N1).

Optionally, the default paging cycle can be used to select or determine the paging cycle.

Optionally, the energy consumption state includes an energy-saving state and/or a normal transmission state.

Optionally, when the base station is in an energy-saving state, actions such as shutting down the radio frequency channel or stopping the transmission of some signals/channels can be performed; when the base station is in a normal transmission state, it can remain powered on and perform normal data transmission with the terminal device.

Optionally, the preset formula includes a first preset formula and/or a second preset formula.

Optionally, the first preset formula is configured to determine the paging frame and the paging occasion in the normal transmission state.

Optionally, the second preset formula is configured to determine the paging frame and the paging occasion in the energy-saving state.

Optionally, based on the paging configuration information, the energy consumption state and the preset formula in the preset strategy, it is possible to achieve continuous placement of paging frames for different terminals within the entire paging cycle, or continuous placement of paging occasions for different terminals, or divide all terminals into a paging compact cycle, thereby achieving the purpose of centralized paging of all terminals within an energy-saving base station or cell, thereby increasing the sleep duration of the energy-saving base station and reducing the energy consumption of the energy-saving base station.
S3: receiving the paging according to the paging frame and/or the paging occasion.

Optionally, the total number of paging frames and/or paging occasions in the paging cycle is kept unchanged. By placing the paging frames and/or the paging occasions continuously in the paging cycle, the function of centralized paging of the base station can be realized, thereby reducing the energy consumption of the base station. At the same time, the total number of paging frames and/or paging occasions in the paging cycle is kept unchanged, and the probability of paging collisions of different terminal devices can also be reduced.

Optionally, a small paging compact cycle can be set in the paging cycle, and the function of the base station to centrally paging different terminals is realized by concentrating the paging frames and/or the paging occasions of different terminals in the paging compact cycle, thereby achieving the purpose of reducing the energy consumption of the base station.

This embodiment adopts the above scheme, specifically by selecting or determining the paging frame and/or the paging occasion where the paging is located based on a preset strategy; receiving the paging according to the paging frame and/or the paging occasion, thereby realizing the compact transmission of the paging frame and/or the paging occasion, reducing the duration of the base station or the cell in the energy-saving state for sending paging in the entire paging cycle, thereby ensuring the sleep duration of the base station or the cell in the energy-saving state.

### Second Embodiment

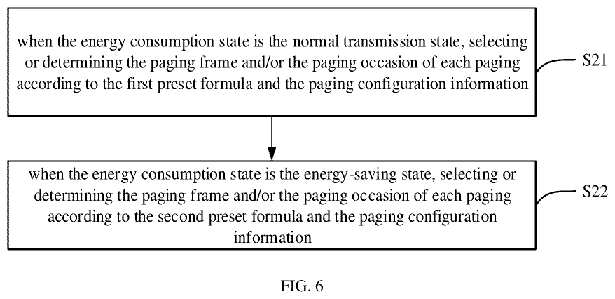

Based on the first embodiment of the present application, this embodiment discloses a specific method for selecting or determining the paging frame and/or the paging occasion in step S2 based on a preset strategy. Referring to FIG. 6, FIG. 6 is a flowchart of the paging transmission method according to the second embodiment, showing that the step S2 include at least one of the following:
S21: when the energy consumption state is the normal transmission state, selecting or determining the paging frame and/or the paging occasion of each paging according to the first preset formula and the paging configuration information.

Optionally, the energy consumption state is a normal state, which means that the number of terminals in the base station or the cell in the connected state exceeds a first threshold, the frequency of data service transmission between the base station or the cell and the terminal exceeds a second threshold, and/or the number of data packets of the data service between the base station or the cell and the terminal exceeds a third threshold.

Optionally, the first preset formula includes a calculation formula (1) for the paging frame and a calculation formula (2) for the paging occasion.

Specifically, the calculation formula (1) for the radio frame where the paging frame in the normal transmission state is located is as follows:

$$( SFN + PF\_offset ) mod T = ( T div N ) * ( UE\_ID mod N ) \qquad ( 1 )$$

The calculation formula (2) for the paging occasion of different terminals in the normal transmission state on the corresponding paging frame is as follows:

$$i\_s = floor ( UE\_ID / N ) mod Ns \qquad ( 2 )$$

According to formulas (1) and (2), the terminal selects or determines the radio frame where the paging frame is located and the position of its paging occasion in the paging frame.

Specifically, the terminal receives the paging message at the (i_s+1)th paging occasion in the paging frame.

Optionally, T is the paging cycle, which is calculated differently in different Radio Resource Control (RRC) states, and is specifically calculated as follows:

RRC_IDLE (RRC idle state): the paging cycle T is the minimum value of the UE-specific cycle configured by NAS and the default paging cycle (defaultPagingCycle) in system information block 1.

RRC_INACTIVE (RRC inactive state): the paging cycle T is the minimum value of the UE-specific cycle configured by NAS, the defaultPagingCycle in system information block 1, and the ran-PagingCycle carried in the RRCRelease message.

Optionally, PF_offset is the paging frame offset: the offset is configured to determine the radio frame where the paging frame (PF) is located, and its value is specified by the field PCCH-Config→nAndPagingFrameOffset in the system information block 1 (SIB1).

Optionally, N is the number of first paging frames in the paging cycle, which is configured to determine the number of PFs included in each discontinuous reception cycle (DRX cycle), and its value is specified by the field PCCH-Config→nAndPagingFrameOffset in SIB1.

Optionally, Ns is the number of first paging occasions contained in each paging frame, which is configured to determine the number of paging occasions (PO) contained in each paging frame, and its value is specified by the field PCCH-Config→ns in SIB1.

Optionally, UE_ID is the UE identity: UE_ID=5G-S-TMSI mod 1024.

The specific configuration values of the above parameters are shown as follows:

PCCH-Config ::= SEQUENCE {

| | |
|---|---|
| defaultPagingCycle | PagingCycle, |

nAndPagingFrameOffset CHOICE {

| | |
|---|---|
| oneT | NULL, |
| halfT | INTEGER (0..1), |
| quarterT | INTEGER (0..3), |
| oneEighthT | INTEGER (0..7), |
| oneSixteenthT | INTEGER (0..15) |
| }, | |
| ns | ENUMERATED {four, two, one}, |

firstPDCCH-MonitoringOccasionOfPO CHOICE {

| | |
|---|---|
| sCS15KHZoneT | SEQUENCE (SIZE (1..maxPO-perPF)) OF |
| INTEGER (0..139), | |
| sCS30KHZoneT-SCS15KHZhalfT | SEQUENCE (SIZE (1..maxPO-perPF)) OF |

INTEGER (0..279),
sCS60KHZoneT-SCS30KHZhalfT-SCS15KHZquarterT SEQUENCE (SIZE
(1..maxPO-perPF)) OF

INTEGER (0..559),

sCS120KHZoneT-SCS60KHZhalfT-SCS30KHZquarterT-SCS15KHZoneEighthT

SEQUENCE (SIZE (1..maxPO-perPF)) OF INTEGER

(0..1119),
sCS120KHZhalfT-SCS60KHZquarterT-SCS30KHZoneEighthT-
SCS15KHZoneSixteenthT

SEQUENCE (SIZE (1..maxPO-perPF)) OF INTEGER

(0..2239),
sCS120KHZquarterT-SCS60KHZoneEighthT-SCS30KHZoneSixteenthT

SEQUENCE (SIZE (1..maxPO-perPF)) OF INTEGER

(0..4479),
sCS120KHZoneEighthT-SCS60KHZoneSixteenthT SEQUENCE (SIZE (1..maxPO-
perPF))

| | |
|---|---|
| | OF INTEGER (0..8959), |
| sCS120KHZoneSixteenthT | SEQUENCE (SIZE (1..maxPO-perPF)) OF |

```
INTEGER (0..17919)
      } OPTIONAL, -- Need R
      ...
  }
    PagingCycle ::= ENUMERATED {rf32, rf64, rf128, rf256}
```

Optionally, assume that the paging cycle T of UE1, UE2 and UE3 obtained according to the user equipment (UE) specific DRX cycle configured by NAS and the default paging cycle configured in SIB1 is configured as rf256, that is, the paging cycle is 256 radio frames, assume that UE1's UE_ID=1, UE2's UE ID=2, UE3's UE_ID=3, PF_offset corresponding to the field PCCH-Config→nAndPagingFrameOffset in SIB1=2, N=T/4, and Ns corresponding to the field PCCH-Config→ns in SIB1=2. According to the calculation formula (1) of the paging frame under the normal transmission state:

$$( SFN + PF\_offset ) mod T = ( T div N ) * ( UE\_ID mod N ) = 4 * ( UE\_ID mod 64 )$$

The radio frame where UE1's paging frame is located is SFN=2, 258, 514, . . .

The radio frame where UE2's paging frame is located is SFN=6, 262, 518, . . .

The radio frame where UE3's paging frame is located is SFN=10, 266, 522, . . .

According to the calculation formula (2) of the paging occasion under the normal transmission state:

$$i\_s = floor ( UE\_ID / N ) mod Ns = floor ( UE\_ID / 64 ) mod 2$$

i_s=0 for UE1, UE2, and UE3, that is, UE1, UE2, and UE3 receive paging messages at the first PO in the paging frame they are in. For example, UE1 receives a paging message at the first paging occasion of radio frame 2, UE2 receives a paging message at the first paging occasion of radio frame 6, and UE3 receives a paging message at the first paging occasion of radio frame 10.

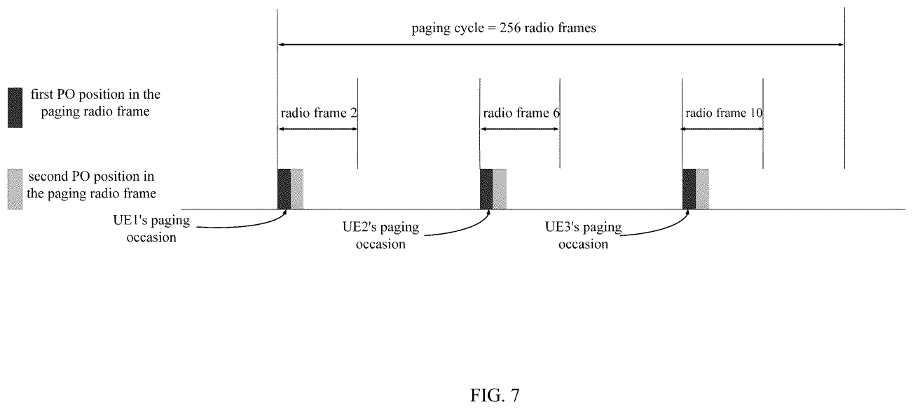

Referring to FIG. 7, FIG. 7 is a first principle schematic diagram of the paging transmission method according to the second embodiment. As shown in FIG. 7, the paging cycle in this embodiment is configured as rf256, that is, the paging cycle contains 256 radio frames. SFN2, SFN6 and SFN10 are the radio frames where the paging occasion of UE1, the paging occasion of UE2 and the paging occasion of UE3 are located, respectively. Each paging occasion and paging frame is evenly dispersed in the paging cycle, which ensures the discreteness of the paging occasion of each terminal device in the high-density terminal distribution scenario and reduces the probability of paging collision of the terminal device.

Combined with formula (1), it can be seen that in normal transmission state, the interval between legacy paging frames is T/N radio frames. When T/N is greater than 1, the interval between legacy paging frames is relatively large, which is not conducive to the base station entering the sleep state. According to formulas (1) and (2), it can be seen that legacy paging frames and/or paging occasions are evenly distributed in the entire paging cycle, which will also cause the base station to be powered on all the time for paging UEs, which will also bring about relatively large energy consumption of the base station. Therefore, the paging operation method in normal state is not suitable for base stations or cells in energy-saving state.
S22: when the energy consumption state is the energy-saving state, selecting or determining the paging frame and/or the paging occasion of each paging according to the second preset formula and the paging configuration information.

Optionally, the energy consumption state is the energy-saving state, which means that the number of terminals in the base station or the cell in the connected state is less than or equal to the first threshold, the frequency of data service transmission between the base station or the cell and the terminal is less than or equal to the second threshold, and or the number of data packets of the data service between the base station or the cell and the terminal is less than or equal to the third threshold.

Optionally, when the energy consumption state of the base station is the energy-saving state, the paging cycle can be divided into two parts: the paging time and the non-paging time according to the second preset formula. The paging frame and/or the paging occasion is placed in the paging time. During the divided non-paging time, the base station or the cell can enter the deep sleep state, thereby realizing energy saving of the base station.

Optionally, there are three ways to place the paging frame and/or the paging occasion at the paging time:

Method 1: continuous placement of PFs of different UEs:

At this time, system frame number (SFN) of the paging frames of different UEs is realized by the following formula (3):

$$( SFN + delta\_f ) mod T = ( ( UE\_ID - 1 ) mod N ) \qquad ( 3 )$$

Optionally, delta_f=PF_offset−(T div N).

Optionally, the specific paging occasions of different UEs in the above paging frame are implemented by the following formula (4):

$$i\_s = floor ( UE\_ID / N ) mod Ns \qquad ( 4 )$$

That is, the UE determines its (i_s+1)th paging occasion in the paging frame according to formula (4) to receive the paging message.

Method 2: continuous placement of POs of different UEs:

In this implementation, it is not necessary to define the paging frame, but only to determine the radio frame in which the first paging occasion is placed in the paging cycle. Specifically, the radio frame in which the first paging occasion is placed in the paging cycle is implemented by the following formula (5):

$$( SFN + delta\_f ) mod T = 0 \qquad ( 5 )$$

Optionally, delta_f=PF_offset−(T div N)

Optionally, the specific paging occasions of different UEs are implemented by the following formula (6):

$$i\_s = ( ( UE\_ID mod N ) * Ns + ( floor ( UE\_ID / N ) mod Ns ) \qquad ( 6 )$$

That is, the UE receives the paging message at the (i_s+1)th paging occasion; formula (5) determines the radio frame where the first paging occasion is located; and the second, third, . . . , and Nth paging occasions are placed in sequence starting from the slot or the symbol in the radio frame where the first paging occasion is located

If the high-layer configuration parameter firstPDCCH-MonitoringOccasionOfPO_ES is used, the starting symbol of the paging search space corresponding to the control channel of the (i_s+1)th paging occasion where the UE is located is the (i_s+1)th value in firstPDCCH-MonitoringOccasionOfPO_ES.

firstPDCCH-MonitoringOccasionOfPO_ES CHOICE {

| | |
|---|---|
| sCS15KHZoneT | SEQUENCE (SIZE (1..maxPO)) OF INTEGER |

(0..139....140*N−1),

| | |
|---|---|
| sCS30KHZoneT-SCS15KHZhalfT | SEQUENCE (SIZE (1..maxPO)) OF |

INTEGER (0.. 279....280*N−1),
sCS60KHZoneT-SCS30KHZhalfT-SCS15KHZquarterT SEQUENCE (SIZE
(1..maxPO)) OF

INTEGER (0..559....560*N−1),

sCS120KHZoneT-SCS60KHZhalfT-SCS30KHZquarterT-SCS15KHZoneEighthT

SEQUENCE (SIZE (1..maxPO)) OF INTEGER

(0..1119.....1120*N−1),
sCS120KHZhalfT-SCS60KHZquarterT-SCS30KHZoneEighthT-
SCS15KHZoneSixteenthT

SEQUENCE (SIZE (1..maxPO)) OF INTEGER

(0..2239.....2240*N−1),
sCS120KHZquarterT-SCS60KHZoneEighthT-SCS30KHZoneSixteenthT

SEQUENCE (SIZE (1..maxPO)) OF INTEGER

(0..4479.....4480*N−1),
sCS120KHZoneEighthT-SCS60KHZoneSixteenthT SEQUENCE (SIZE (1..maxPO))

| | |
|---|---|
| | OF INTEGER (0..8959....8960*N−1), |
| sCS120KHZoneSixteenthT | SEQUENCE (SIZE (1..maxPO-perPF)) OF INTEGER |

(0..17919.....17920*N−1)
}

Optionally, firstPDCCH-MonitoringOccasionOfPO_ES can be configured by SIB1 or Radio Resource Control (RRC).

Method 3: configure a paging compact cycle in the paging cycle, and the paging frames or paging occasions of different UEs are located in the paging compact cycle, and are no longer evenly distributed in the entire paging cycle.

Specifically, the paging compact cycle parameter ES duration and the paging frame number parameter N1 in the paging compact cycle can be set first.

$$Optionally , ES duration : : = ENUMERATED \{ rf 1 , rf 2 , rf 4 , rf 8 , rf 16 \}$$

Optionally, ES duration can also be other period values that satisfy ES duration<paging cycle, and the unit of the paging compact cycle ES duration can be the number of radio frames, or the number of subframes, the number of slots, or the number of symbols.

Optionally, N1 needs to satisfy the following formula (7).

$$N 1 = \frac{ES duration}{{2}^{x}} >= 1 \qquad ( 7 )$$

x is a natural number.

Optionally, the parameters ES duration and N1 can be configured by system information or radio resource control parameters.

The method for determining the paging frames of different UEs in the paging compact cycle in method three is as follows:

First, the first paging frame (PF) in the entire paging cycle is determined by the following formula (8):

$$( SFN + PF\_offset ) mod T = ( T div N ) \qquad ( 8 )$$

Secondly, the paging frame of the paging message received by different UEs in the paging compact cycle is determined by the following formula (9):

$$( SFN 1 + delta\_f ) mod ES duration = ( ( ES duration ) div N 1 ) * ( UE\_ID mod N 1 ) \qquad ( 9 )$$

Optionally, delta_f=PF_offset−(T div N)+(ES duration) div N1.

That is, the radio frame of the first paging frame in the paging cycle is determined by formula (8), and then the paging frames of different UEs in the paging compact cycle are determined by formula (9). The system frame number of the paging frames of different UEs in the paging compact cycle is greater than or equal to the system frame number determined by formula (8). After determining the paging frames of different UEs receiving the paging messages in the paging compact cycle, the specific paging occasion for receiving the paging messages needs to be determined by formula (10):

$$i\_s = floor ( UE\_ID / N 1 ) mod Ns \qquad ( 10 )$$

Optionally, in the above three implementations, the slot or the symbol where the paging occasion is located is related to the configuration of the control resource set corresponding to the paging and the search space set corresponding to the paging.

Optionally, delta_f in the above three implementations can also be semi-statically configured by system information or radio resource control parameters.

Optionally, delta_f in the above three implementations can also be other preset values.

In this embodiment, through the above solution, when the energy consumption state is the normal transmission state, the paging frame and/or the paging occasion of each paging is selected or determined according to the first preset formula and the paging configuration information; when the energy consumption state is the energy-saving state, the paging frame and/or the paging occasion of each paging is selected or determined according to the second preset formula and the paging configuration information. By distinguishing the energy consumption state, the paging frame and/or the paging occasion of the paging is determined according to the first preset formula and the paging configuration information in the normal transmission state, and the paging cycle is divided into two parts, the paging time and the non-paging time, according to the second preset formula in the energy-saving state, and the paging frame and/or the paging occasion is placed in the paging time. In the divided non-paging time, the base station or the cell can enter the deep sleep state, thereby achieving the purpose of energy saving of the base station.

### Third Embodiment

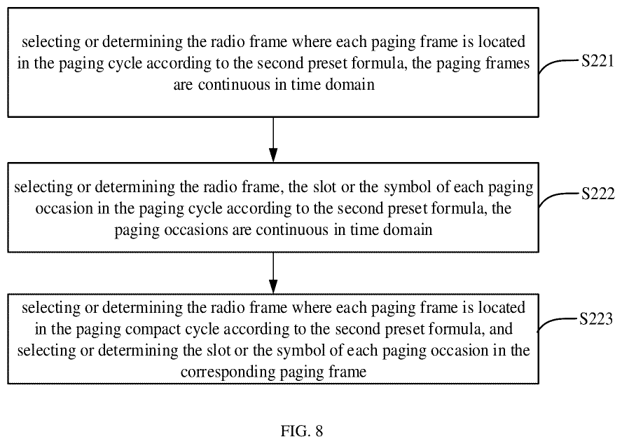

On the basis of the first embodiment and the second embodiment of the present application, this embodiment discloses a specific method for selecting or determining the paging frame and/or the paging occasion of each paging according to the second preset formula and the paging configuration information in step S22. Referring to FIG. 8, FIG. 8 is a flowchart of the paging transmission method according to the third embodiment, showing that the step S22 include at least one of the following:
S221: selecting or determining the radio frame where each paging frame is located in the paging cycle according to the second preset formula. Optionally, the paging frames are continuous in time domain, corresponding to the method included in step S22 in the second embodiment.

Optionally, the method further includes at least one of the following:
selecting the first radio frame where the paging occasion is located from the paging cycle, and continuously arranging the radio frame where each paging occasion is located based on the first radio frame.

The radio frame, the slot or the symbol where each paging occasion is located is associated with the configuration of the paging search space.

Optionally, the method further includes at least one of the following:

The number of paging occasions contained in each paging frame in the radio frame where each paging frame is located is equal to the number of first paging occasions contained in each paging frame.

The number of each paging frame in the radio frame where each paging frame is located is equal to the number of first paging frames in the paging cycle.

Specifically, assume that the paging cycle T of UE1˜UE3 obtained based on the default paging cycle in system information block 1 and the UE-specific DRX cycle configured by NAS is configured as rf256, that is, the paging cycle of UE1˜UE3 is 256 radio frames; assume that UE1's UE_ID=1, UE2's UE_ID=2, UE3's UE_ID=3, the PF_offset corresponding to the field PCCH-Config→nAndPagingFrameOffset in SIB1 is 2, N=T/4, and the Ns corresponding to the field PCCH-Config→ns in SIB1 is 2.

First, the radio frame where the paging frames of UE1˜UE3 are located is calculated according to formula (3):

Assume delta_f=PF_offset−(T div N)=2−4=−2, then formula (3) becomes:

$$( SFN - 2 ) mod 256 = ( UE\_ID - 1 ) mod 64$$

Therefore, the specific radio frames where the paging frames of UE1˜UE3 are located are:

The radio frames where the paging frames of UE1 are located are SFN=2, 258, 514, . . .

The radio frames where the paging frames of UE2 are located are SFN=3, 259, 515, . . .

The radio frames where the paging frames of UE3 are located are SFN=4, 260, 516, . . .

Secondly, the specific paging occasions of UE1˜UE3 in the paging frames are calculated according to formula (4):

$$i\_s = floor ( UE\_ID / N ) mod Ns = floor ( UE\_ID / 64 ) mod 2$$

Therefore, UE1˜UE3 receive paging messages at the first PO in their respective paging frames. For example, UE1 receives paging messages at the first paging occasion of radio frame 2, UE2 receives paging messages at the first paging occasion of radio frame 3, and UE3 receives paging messages at the first paging occasion of radio frame 4.

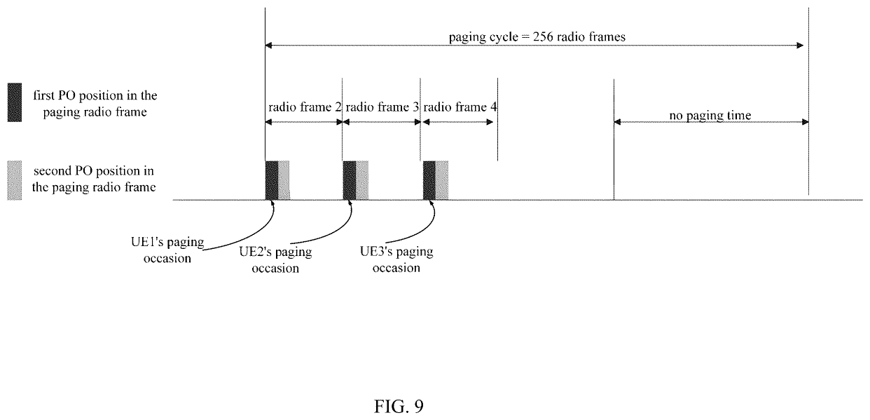

As shown in FIG. 9, FIG. 9 is a first principle schematic diagram of the paging transmission method according to the third embodiment. As shown in FIG. 9, the paging cycle in this embodiment includes 256 radio frames, and the paging occasion of UE1, the paging occasion of UE2 and the paging occasion of UE3 are respectively located in radio frame 2, radio frame 3 and radio frame 4. Compared with FIG. 7, this method can realize the sequential placement of paging frames of different UEs, and then realize the centralized paging of different UEs, thereby leaving a period of time in the paging cycle without paging so that the base station can enter the sleep state and save the energy consumption of the base station.

Through the method of this embodiment, the base station no longer places paging frames discretely, but places paging frames of different UEs in sequence and continuously, so that the paging of the base station can be completed in a shorter time, so as to leave more time for the base station to enter the sleep state in the entire paging cycle, save the energy consumption of the base station, and at the same time do not affect the number of paging frames in the entire paging cycle, thereby reducing the probability of collision of paging occasions between different users.
S222: selecting or determining the radio frame, the slot or the symbol of each paging occasion in the paging cycle according to the second preset formula. Optionally, the paging occasions are continuous in time domain, corresponding to the second method included in step S22 in the second embodiment.

Optionally, the method further includes at least one of the following:

The number of paging occasions included in each radio frame of the radio frame where each paging occasion is located is greater than or equal to the number of first paging occasions contained in each paging frame.

The number of radio frames where each paging occasion is located is less than or equal to the first number of paging frames in the paging cycle.

Specifically, assume that the paging cycle T of UE1˜UE3 obtained by defaultPagingCycle in system information block 1 according to the UE-specific DRX cycle configured by NAS is rf256, that is, the paging cycle of UE1˜UE3 is 256 radio frames; assume that UE1's UE_ID=1, UE2's UE_ID=2, UE3's UE ID=3, the PF_offset corresponding to the field PCCH-Config→nAndPagingFrameOffset in SIB1 is 2, N=T/4, and the Ns corresponding to the field PCCH-Config→ns in SIB1 is 2.

First, the radio frame for placing the first paging occasion in the paging cycle of UE1˜UE3 is calculated according to formula (5) as follows:

Assume delta_f=PF_offset−(T div N)=2−4=−2, then formula (5) becomes:

$$( SFN + delta\_f ) mod T = ( SFN - 2 ) mod 64 = 0$$

Therefore, the radio frame in which the first paging occasion is placed in the paging cycle of UE1˜UE3 is radio frame 2, that is, the radio frame in which the first paging occasion is placed in the paging cycle is SFN=2

Secondly, according to formula (6), the paging occasions of UE1˜UE3 are calculated as follows:

$$i\_s = ( UE\_ID mod N ) * Ns + ( floor ( UE\_ID / N ) mod Ns = ( UE\_ID mod 64 ) * 2 + ( floor ( UE\_ID / 64 ) mod 2$$

The paging occasion of UE1 is located at the third paging occasion starting from the first paging occasion in the radio frame in which the first paging occasion is placed in the paging cycle.

The paging occasion of UE2 is located at the fifth paging occasion starting from the first paging occasion in the radio frame in which the first paging occasion is placed in the paging cycle.

The paging occasion of UE3 is located at the seventh paging occasion starting from the first paging occasion in the radio frame in which the first paging occasion is placed in the paging cycle.

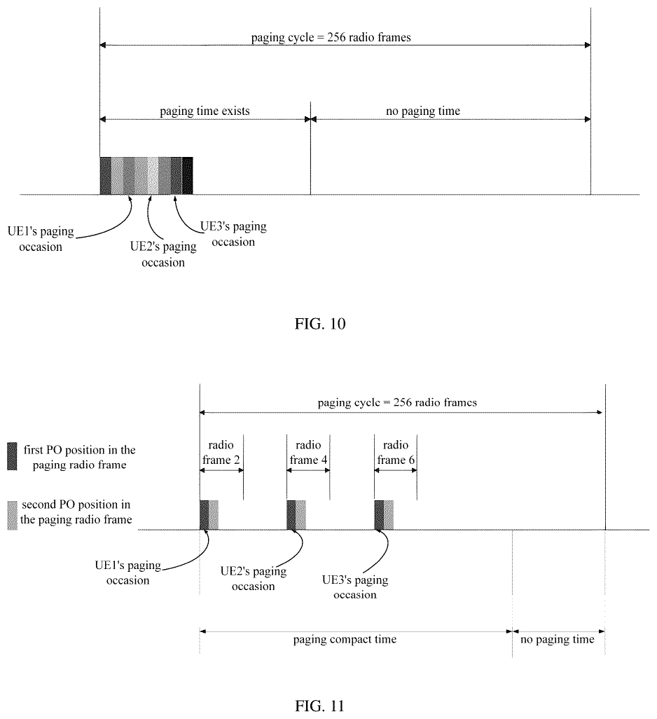

As shown in FIG. 10, FIG. 10 is a second principle schematic diagram of the paging transmission method according to the third embodiment. As shown in FIG. 10, the paging cycle in this embodiment includes 256 radio frames, and the paging occasions of different UEs are no longer discretely distributed in the paging frames in the entire paging cycle, but are concentrated in one or more continuous radio frames. Compared with FIG. 7 and FIG. 9, the paging time of the base station is further concentrated, and more sleep time is reserved for the base station, thereby saving the energy consumption of the base station, while ensuring the number of paging occasions in the paging cycle, and further reducing the collision probability of paging occasions between different users.
S223: selecting or determining the radio frame where each paging frame is located in the paging compact cycle according to the second preset formula, and selecting or determining the slot or the symbol of each paging occasion in the corresponding paging frame, which corresponds to method three included in step S22 in the second embodiment.

Specifically, assume that the paging cycle T of UE1˜UE3 obtained based on the default paging cycle in system information block 1 and the UE-specific DRX cycle configured by NAS is rf256, that is, the paging cycle of UE1˜UE3 is 256 radio frames; assume that UE1's UE_ID=1, UE2's UE_ID=2, UE3's UE_ID=3, the PF_offset corresponding to the field PCCH-Config→nAndPagingFrameOffset in SIB1 is 2, N=T/4, the Ns corresponding to the field PCCH-Config→ns in SIB1 is 2, the paging compact cycle ES duration=rf8, and the number of paging frames in the paging compact cycle N1=ES duration/2.

Firstly, the radio frame of the first paging frame in the entire paging cycle is calculated according to formula (8):

$$( SFN + 2 ) mod 256 = 4$$

Therefore, the radio frame where the first paging frame in the entire paging cycle is located is in radio frame 2.

Secondly, the paging frame of the received paging message in the paging compact cycle where UE1˜UE3 is located is calculated according to formula (9):

Let delta_f=PF_offset−(T div N)+(ES duration) div N1=2−4+2=0, then

$$( SFN 1 + 0 ) mod 8 = 2 * ( UE\_ID mod 4 )$$

That is, the paging frame for receiving the paging messages of UE1 in the paging compact cycle is located in the radio frame SFN=2, 258, 514, . . .

The paging frame for receiving the paging messages of UE2 in the paging compact cycle is located in the radio frame SFN=4, 260, 516, . . .

The paging frame for receiving the paging messages of UE3 in the paging compact cycle is located in the radio frame SFN=8, 264, 520, . . .

Finally, according to formula (10), the paging occasion of UE1˜UE3 in the paging frame determined by the above formulas (8) and (9) in the paging compact cycle is calculated:

$$i\_s = floor ( UE\_ID / N 1 ) mod Ns = floor ( UE\_ID / 4 ) mod 2$$

UE1, UE2, and UE3 receive paging messages at the first PO in their respective PFs.

As shown in FIG. 11, FIG. 11 is a third principle schematic diagram of the paging transmission method according to the third embodiment. As shown in FIG. 11, the paging cycle in this embodiment includes 256 radio frames. According to the second preset formula, the paging compact cycle (ES duration) and the non-paging time are divided in the paging cycle. The paging occasion of UE1, the paging occasion of UE2 and the paging occasion of UE3 are respectively located in the first paging occasion of radio frame 2, radio frame 4 and radio frame 8 in the paging compact cycle. By dividing the paging compact cycle in the paging cycle, the paging frames and paging occasions corresponding to each terminal are concentrated in the paging compact cycle.

Optionally, within a paging compact cycle, paging frames and/or paging occasions of different UEs may be placed evenly as shown in FIG. 11, or paging frames of different UEs may be placed sequentially and continuously (refer to FIG. 9), and/or paging occasions of different UEs may be placed sequentially and continuously (refer to FIG. 10), thereby ensuring the discreteness of the paging occasions and realizing paging of the base station in a shorter time, thereby leaving more time for the base station to enter a sleep state during the paging cycle, thereby saving energy consumption of the base station.

In this embodiment, through the above solution, according to the second preset formula, the radio frame where each paging frame is located is selected or determined in the paging cycle, and optionally, the paging frames are continuous in time domain; and/or, according to the second preset formula, the radio frame, the slot or the symbol where each paging occasion is located is selected or determined in the paging cycle, and optionally, the paging occasions are continuous in time domain; and/or, according to the second preset formula, the radio frame where each paging frame is located is selected or determined in the paging compact cycle, and the slot or the symbol of each paging occasion in the corresponding paging frame is selected or determined. When T/N is greater than 1, the interval between legacy paging frames is T/N radio frames, and the radio frames are evenly distributed throughout the paging cycle. The base station needs to be in an awake state to perform paging, which is not conducive to the base station entering an energy-saving state (such as closing the radio frequency channel, etc.), and is not conducive to saving energy consumption of the base station. Through the method of this embodiment, based on the preset formula, the paging frame is continuously configured, the paging occasion is continuously configured, or the paging cycle is divided into a paging time and a non-paging time, and the paging frame and the paging occasion are configured according to the new paging configuration parameters. While ensuring the discrete characteristics of the paging occasion of the terminal, the base station can page in a shorter time through fewer radio frames, so as to leave more time for the base station to enter the sleep state in the paging cycle, saving energy consumption of the base station.

### Fourth Embodiment

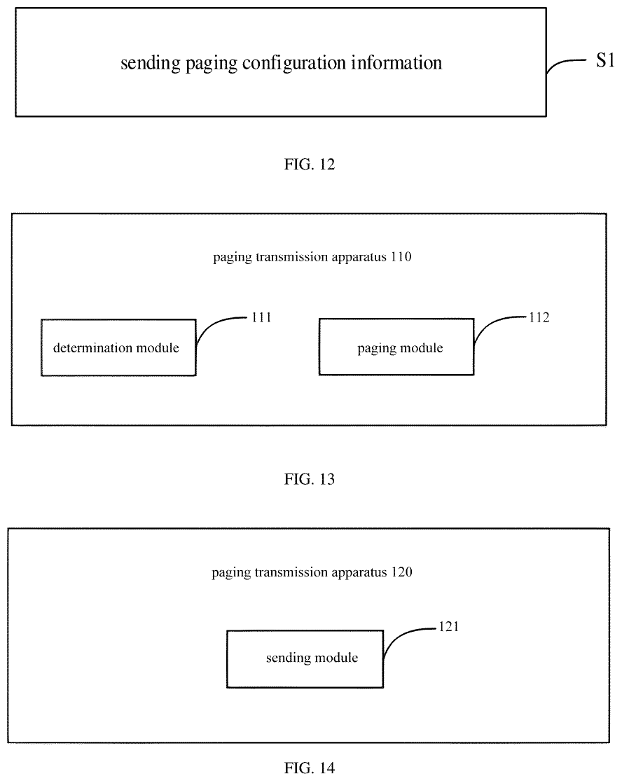

As shown in FIG. 12, FIG. 12 is a flowchart of a paging transmission method according to the fourth embodiment. The method of the embodiment of the present application can be applied to a network device (such as a base station). The paging transmission method includes the following steps:
S1: sending paging configuration information so that the terminal can select or determine the paging frame and/or the paging occasion where the paging is located based on a preset strategy, and receive paging according to the paging frame and/or the paging occasion.

Optionally, the preset strategy includes at least one of the following: paging configuration information, energy consumption state and preset formula.

Optionally, the method further includes at least one of the following:

The paging configuration information includes a default paging cycle, a paging frame offset (PF_offset), the number of first paging frames in the paging cycle (N), the number of first paging occasions contained in each paging frame (Ns), a paging compact cycle (ES duration) and the number of paging frames in the paging compact cycle (N1).

Optionally, the default paging cycle can be configured to select or determine the paging cycle.

Optionally, the paging compact cycle is less than the default paging cycle, the number of paging frames in the paging compact cycle is equal to (paging compact cycle/2^{x}), where x is a natural number.

Optionally, the energy consumption state includes an energy-saving state and/or a normal transmission state.

Optionally, when the base station is in an energy-saving state, the radio frequency channel can be turned off, etc.

Optionally, when the base station is in a normal transmission state, it remains powered on and can perform normal data transmission with the terminal device.

Optionally, the preset formula includes a first preset formula and/or a second preset formula.

Optionally, the first preset formula is configured to determine the paging frame and the paging occasion in the normal transmission state, that is, the legacy paging definition formula.

Optionally, the second preset formula is configured to determine the paging frame and the paging occasion in the energy-saving state, that is, the newly defined paging definition formula.

Optionally, the method further includes: dividing the paging cycle into a paging time and a non-paging time based on the second preset formula.

Optionally, the method further includes at least one of the following:
the paging compact cycle is less than the paging cycle;
the number of paging frames in the paging compact cycle is less than or equal to the first number of paging frames in the paging cycle, and the first number of paging frames in the paging cycle is an integer multiple of the number of paging frames in the paging compact cycle.

Optionally, the second preset formula is configured to select or determine the radio frame where each paging frame is located in the paging cycle, and optionally, each paging frame is continuous in time domain.

Optionally, the second preset formula is configured to select or determine the radio frame, the slot or the symbol where each paging occasion is located in the paging cycle, and optionally, each paging occasion is continuous in time domain.

Optionally, the second preset formula is configured to select or determine the radio frame where each paging frame is located in the paging compact cycle, and select or determine the slot or the symbol of each paging occasion in the corresponding paging frame.

Optionally, the second preset formula divides the paging cycle into two parts: a paging time and a non-paging time; and/or, the paging frames of different UEs determined according to the second preset formula are continuous in time domain; and/or, the paging occasions of different UEs determined according to the second preset formula are continuous in time domain and are only related to the first paging frame in the paging cycle; and/or, the duration of the paging frames and paging occasions of different UEs determined according to the second preset formula does not exceed the size of the paging compact cycle.

Optionally, when the paging frames of different UEs determined according to the second preset formula are continuous in time domain, the number of paging occasions included in a radio frame is equal to Ns; and/or the number of paging radio frames in the paging cycle is equal to N.

Optionally, when the paging occasions of different UEs determined according to the second preset formula are continuous in time domain, the number of paging occasions included in a radio frame is greater than or equal to Ns, and is related to the configuration of the paging search space; and/or, the radio frames where the consecutive paging occasions are located are arranged continuously from the first paging frame in the paging cycle; and/or, the number of radio frames where the paging occasions are located in the paging cycle is less than or equal to N.

Optionally, based on the paging configuration information, the energy consumption state and the preset formula in the preset strategy, the paging frames are placed continuously in the entire paging cycle, or the paging occasions are placed continuously, or the paging compact cycle is divided to achieve centralized paging.

In this embodiment, through the above solution, by sending paging configuration information, the terminal selects or determines the paging frame and/or the paging occasion for the paging based on a preset strategy, and receives the paging according to the paging frame and/or the paging occasion, thereby achieving compact transmission of the paging frame and/or the paging occasion, and reducing the duration used for sending paging within the entire paging cycle for the base station or the cell in the energy-saving state, thereby ensuring the sleep duration of the base station or the cell in the energy-saving state.

### Fifth Embodiment

Based on the above embodiments of the present application, this embodiment further discloses the paging transmission method in the above embodiments.

In the embodiment of the present application, a network device (such as a base station) sends paging configuration information to a terminal device (such as a mobile phone).

Optionally, the paging configuration information sent by the network device (such as a base station) includes at least one of a default paging cycle, a paging frame offset (PF_offset), the number of first paging frames in the paging cycle (N), the number of first paging occasions contained in each paging frame (Ns), a paging compact cycle (ES duration), and the number of paging frames in the paging compact cycle (N1). Optionally, the default paging cycle can be configured to select or determine the paging cycle.

Optionally, the paging compact cycle is less than the default paging cycle; the number of paging frames in the paging compact cycle is equal to (paging compact cycle/ [symbol] ), where x is a natural number.

Optionally, the energy consumption state includes an energy-saving state and/or a normal transmission state. Optionally, when the base station is in the energy-saving state, the radio frequency channel can be turned off; when the base station is in the normal transmission state, it remains powered on and can perform normal data transmission with the terminal device.

Optionally, the preset formula includes a first preset formula and/or a second preset formula.

Optionally, the first preset formula is configured to determine the paging frame and the paging occasion in the normal transmission state, that is, the legacy paging definition formula.

Optionally, the second preset formula is configured to determine the paging frame and the paging occasion in the energy-saving state, that is, the newly defined paging definition formula.

Optionally, the method further includes: dividing the paging cycle into paging time and non-paging time based on the second preset formula.

Optionally, the terminal device (such as a mobile phone) receives the paging configuration information sent by the network device, selects or determines the paging frame and/or the paging occasion where the paging is located based on the preset strategy, and then receives paging according to the paging frame and/or the paging occasion.

Optionally, the preset strategy includes at least one of the following: paging configuration information, energy consumption state and preset formula.

Optionally, the network device sends the paging configuration information and/or energy consumption state to the terminal device.

Optionally, the preset formula is pre-stored in the network device and/or the terminal device.

Optionally, when the energy consumption state of the network device is a normal transmission state, the terminal device selects or determines the paging frame and/or the paging occasion of each paging according to the first preset formula and the paging configuration information.

Optionally, when the energy consumption state of the network device is an energy-saving state, the terminal device selects or determines the paging frame and/or the paging occasion of each paging according to the second preset formula and the paging configuration information.

Optionally, selecting or determining, by the terminal device, the paging frame and/or the paging occasion of each paging according to the second preset formula and the paging configuration information includes at least one of the following:
selecting or determining the radio frame where each paging frame is located in the paging cycle according to the second preset formula, and optionally, the paging frames are continuous in time domain;
selecting or determining the radio frame, the slot or the symbol where each paging occasion is located in the paging cycle according to the second preset formula, and optionally, the paging occasions are continuous in time domain;
selecting or determining the radio frame where each paging frame is located in the paging compact cycle according to the second preset formula, and selecting or determining the slot or the symbol of each paging occasion in the corresponding paging frame.

Optionally, the second preset formula divides the paging cycle into two parts: a paging time and a non-paging time; and/or, the paging frames of different UEs determined according to the second preset formula are continuous in time domain; and/or, the paging occasions of different UEs determined according to the second preset formula are continuous in time domain and are only related to the first paging frame in the paging cycle; and/or, the duration of the paging frames and the paging occasions of different UEs determined according to the second preset formula does not exceed the size of the paging compact cycle.

Optionally, when the paging frames of different UEs determined according to the second preset formula are continuous in time domain, the number of paging occasions included in a radio frame is equal to Ns; and/or the number of paging radio frames in the paging cycle is equal to N.

Optionally, when the paging occasions of different UEs determined according to the second preset formula are continuous in time domain, the number of paging occasions included in a radio frame is greater than or equal to Ns, and is related to the configuration of the paging search space; and/or, the radio frames where the continuous paging occasions are located are arranged continuously starting from the first paging frame in the paging cycle; and/or, the number of radio frames where the paging occasions are located in the paging cycle is less than or equal to N.

In this embodiment, through the above solution, the network device sends paging configuration information to the terminal device, so that the terminal device selects or determines the paging frame and/or the paging occasion where the paging is located based on a preset strategy, and then receives the paging according to the paging frame and/or the paging occasion. The compact transmission of the paging frame and/or the paging occasion is realized in the paging cycle, which better reduces the duration of the base station or the cell in the energy-saving state for sending paging in the entire paging cycle, and ensures the sleep duration of the base station or the cell in the energy-saving state.

As shown in FIG. 13, FIG. 13 is a first schematic structural diagram of a paging transmission apparatus according to an embodiment of the present application. The apparatus can be mounted on a terminal device in the above method embodiment, and the device can be a server. The paging transmission apparatus shown in FIG. 13 can perform some or all of the functions in the method embodiment described in the above embodiment. As shown in FIG. 13, the paging transmission apparatus 110 includes a determination module 111 and a paging module 112.

The determination module 111 is configured to select or determine the paging frame and/or the paging occasion where the paging is located based on a preset strategy.

The paging module 112 is configured to receive paging according to the paging frame and/or the paging occasion.

Optionally, the preset strategy includes at least one of the following: paging configuration information, energy consumption state and preset formula.

Optionally, the paging configuration information includes at least one of the following: default paging cycle, paging frame offset, the number of first paging frames in the paging cycle, the number of first paging occasions contained in each paging frame, paging compact cycle and the number of paging frames in the paging compact cycle.

Optionally, the energy consumption state includes a normal transmission state and/or an energy-saving state.

Optionally, the preset formula includes a first preset formula and/or a second preset formula.

Optionally, the first preset formula is configured to determine the paging frame and the paging occasion in the normal transmission state, that is, the legacy paging definition formula.

Optionally, the second preset formula is configured to determine the paging frame and the paging occasion in the energy-saving state, that is, the newly defined paging definition formula.

Optionally, the second preset formula is configured to divide the paging cycle into paging time and non-paging time.

Optionally, step S2 includes at least one of the following:
when the energy consumption state is the normal transmission state, selecting or determining the paging frame and/or the paging occasion of each paging according to the first preset formula and the paging configuration information;
when the energy consumption state is the energy-saving state, selecting or determining the paging frame and/or the paging occasion of each paging according to the second preset formula and the paging configuration information.

Optionally, the step of selecting or determining the paging frame and/or the paging occasion of each paging according to the second preset formula and the paging configuration information includes at least one of the following:
selecting or determining the radio frame where each paging frame is located in the paging cycle according to the second preset formula, and optionally, the paging frames are continuous in time domain;
selecting or determining the radio frame, the slot or the symbol where each paging time is located in the paging cycle according to the second preset formula, and optionally, the paging occasions are continuous in time domain;
selecting or determining the radio frame where each paging frame is located in the paging compact cycle according to the second preset formula, and selecting or determining the slot or the symbol of each paging occasion in the corresponding paging frame.

Optionally, the step of selecting or determining the radio frame where each paging frame is located in the paging cycle according to the second preset formula further includes at least one of the following:
selecting the first radio frame where the paging occasion is located from the paging cycle, and continuously arranging the radio frame where each paging occasion is located based on the first radio frame;
the radio frame, the slot or the symbol where each paging occasion is located is associated with the configuration of the paging search space.

Optionally, the number of paging occasions contained in each paging frame in the radio frame where each paging frame is located is equal to the number of first paging occasions contained in each paging frame.

Optionally, the number of paging frames in the radio frame where each paging frame is located is equal to the number of first paging frames in the paging cycle.

Optionally, the number of paging occasions included in each radio frame where each paging occasion is located is greater than or equal to the number of first paging occasions contained in each paging frame.

Optionally, the number of radio frames in the radio frame where each paging occasion is located is less than or equal to the number of first paging frames in the paging cycle.

The paging transmission apparatus provided in the embodiment of the present application can execute the technical solution shown in the above method embodiment, and its implementation principle and beneficial effects are similar, which will not be repeated here.

As shown in FIG. 14, FIG. 14 is a second structural diagram of a paging transmission apparatus according to an embodiment of the present application. As shown in FIG. 14, the paging transmission apparatus 120 includes a sending module 121.

The sending module 121 is configured to send paging configuration information so that the terminal can select or determine the paging frame and/or the paging occasion where the paging is located based on a preset strategy, and receive paging according to the paging frame and/or the paging occasion.

Optionally, the preset strategy includes at least one of the following: paging configuration information, energy consumption state, and preset formula.

Optionally, the paging configuration information includes at least one of the following: a default paging cycle, a paging frame offset, the number of first paging frames in a paging cycle, the number of first paging occasions contained in each paging frame, a paging compact cycle, and the number of paging frames in a paging compact cycle.

Optionally, the preset formula includes a first preset formula and/or a second preset formula.

Optionally, the first preset formula is configured to determine the paging frame and the paging occasion in a normal transmission state, that is, a legacy paging definition formula.

Optionally, the second preset formula is configured to determine the paging frame and the paging occasion in the energy-saving state, that is, the newly defined paging definition formula.

Optionally, the paging cycle is divided into paging time and non-paging time based on the second preset formula.

Optionally, the paging compact cycle is smaller than the paging cycle.

Optionally, the number of paging frames in the paging compact cycle is less than or equal to the first number of paging frames in the paging cycle, and the first number of paging frames in the paging cycle is an integer multiple of the number of paging frames in the paging compact cycle.

Optionally, the second preset formula is configured to select or determine the radio frame where each paging frame is located in the paging cycle, and optionally, paging frames are continuous in time domain.

Optionally, the second preset formula is configured to select or determine the radio frame, the slot or the symbol where each paging occasion is located in the paging compact cycle, and select or determine the slot or the symbol of each paging occasion in the corresponding paging frame.

The paging transmission apparatus provided in the embodiment of the present application can execute the technical solution shown in the above method embodiment, and its implementation principle and beneficial effects are similar, which will not be repeated here.

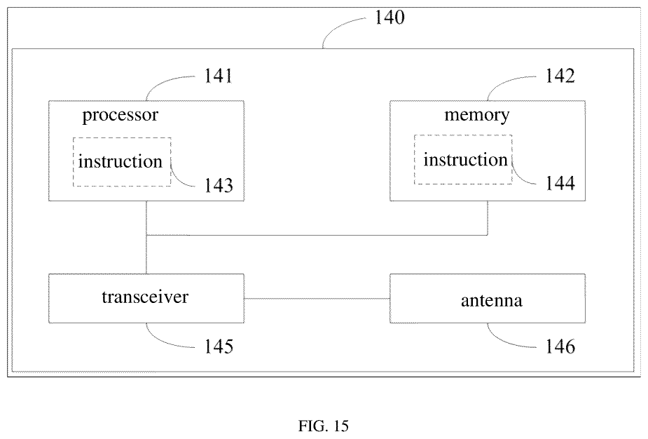

As shown in FIG. 15, FIG. 15 is a schematic structural diagram of a communication device according to an embodiment of the present application. As shown in FIG. 15, the communication device 140 described in this embodiment can be a terminal device (or a component that can be used for a terminal device) or a network device (or a component that can be used for a network device) mentioned in the aforementioned method embodiment. The communication device 140 can implement the method corresponding to the terminal device or the network device described in the aforementioned method embodiment, and specifically refer to the description in the aforementioned method embodiment.

The communication device 140 may include one or more processors 141, which may also be referred to as a processing unit, and may implement certain control or processing functions. The processor 141 may be a general-purpose processor or a dedicated processor, etc. For example, it may be a baseband processor or a central processing unit. The baseband processor may process the communication protocol and communication data, and the central processing unit may control the communication device, execute the software program, and process the data of the software program.

Optionally, the processor 141 may also store instructions 143 or data (such as intermediate data). Optionally, the instructions 143 may be executed by the processor 141, so that the communication device 140 executes the method corresponding to the terminal device or network device described in the above method embodiment.

Optionally, the communication device 140 may include a circuit, which may implement the function of sending or receiving or communicating in the above method embodiment.

Optionally, the communication device 140 may include one or more memories 142, on which instructions 144 may be stored, and the instructions may be executed on the processor 141, so that the communication device 140 executes the method described in the above method embodiment.

Optionally, data may also be stored in the memory 142. The processor 141 and the memory 142 may be set separately or integrated together.

Optionally, the communication device 140 may also include a transceiver 145 and/or an antenna 146. The processor 141 may be called a processing unit, which controls the communication device 140 (terminal device or core network device or wireless access network device). The transceiver 145 may be referred to as a transceiver unit, a transceiver, a transceiver circuit, or a transceiver, etc., and is configured to implement the transceiver function of the communication device 140.

Optionally, if the communication device 140 is configured to implement the operations corresponding to the terminal device in the above embodiments, for example, the transceiver 145 can receive the paging configuration information; and the processor 141 selects or determines the paging frame and/or the paging occasion where the paging is located based on a preset strategy, and performs paging reception according to the paging frame and/or the paging occasion.

Optionally, the specific implementation process of the processor 141 and the transceiver 145 can refer to the relevant description of the above embodiments, which will not be repeated here.

Optionally, if the communication device 140 is configured to implement the operations corresponding to the network devices in the above embodiments, for example, the transceiver 145 can send paging configuration information so that the terminal can select or determine the paging frame and/or the paging occasion where the paging is located based on a preset strategy, and receive the paging according to the paging frame and/or the paging occasion.

Optionally, the specific implementation process of the processor 141 and the transceiver 145 can refer to the relevant description of the above embodiments, which will not be repeated here.

The processor 141 and the transceiver 145 described in the present application can be implemented in an Integrated Circuit (IC), an analog integrated circuit, a Radio Frequency Integrated Circuit (RFIC), a mixed signal integrated circuit, an Application Specific Integrated Circuit (ASIC), a Printed Circuit Board (PCB), an electronic device, etc. The processor 141 and the transceiver 145 can also be manufactured using various integrated circuit process technologies, such as Complementary Metal Oxide Semiconductor (CMOS), N Metal-Oxide-Semiconductor (NMOS), Positive channel Metal Oxide Semiconductor (PMOS), Bipolar Junction Transistor (BJT), bipolar CMOS (BiCMOS), silicon germanium (SiGe), gallium arsenide (GaAs), etc.

In the present application, the communication device can be a terminal device (such as a mobile phone) or a network device (such as a base station), which needs to be determined according to the context. In addition, the terminal device can be implemented in various forms. For example, the terminal devices described in the present application can include mobile terminals such as mobile phones, tablet computers, laptops, PDAs, portable media players (PMPs), navigation devices, wearable devices, smart bracelets, pedometers, etc., as well as fixed terminal devices such as digital TVs and desktop computers.

Although in the above embodiment description, the communication device is described as a terminal device or a network device, the scope of the communication device described in the present application is not limited to the above terminal device or network device, and the structure of the communication device may not be limited by FIG. 15. The communication device may be an independent device or may be part of a larger device.

The embodiment of the present application further provides a communication system, including: a terminal device as in any of the above method embodiments; and a network device as in any of the above method embodiments.

The embodiment of the present application further provides a communication device, including a memory and a processor, the memory stores a paging transmission program, and the paging transmission program is executed by the processor to implement the steps of the paging transmission method in any of the above embodiments. The communication device in the present application may be a terminal device (such as a mobile phone) or a network device (such as a base station), and the specific reference needs to be clarified according to the context.

The embodiment of the present application further provides a storage medium, the storage medium stores a paging transmission program, and the paging transmission program is executed by the processor to implement the steps of the paging transmission method in any of the above embodiments.

In the embodiments of the communication device and storage medium provided in the embodiments of the present application, all technical features of any of the above-mentioned paging transmission method embodiments may be included, and the expansion and explanation of the specification are basically the same as the embodiments of the above-mentioned methods, and will not be repeated here.

The embodiments of the present application further provide a computer program product, which includes a computer program code. When the computer program code is run on a computer, the computer executes the method in the above-mentioned various possible implementations.

The embodiments of the present application further provide a chip, including a memory and a processor, the memory is configured to store a computer program, and the processor is configured to call and run the computer program from the memory, so that the device equipped with the chip executes the method in the above-mentioned various possible implementations.

It can be understood that the above-mentioned scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are for description only and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terminology, technical solution and/or application scenario description is generally described in detail only when it appears for the first time. When it appears again later, it is generally not repeated for the sake of brevity. When understanding the technical solution and other contents of the present application, for the same or similar terminology, technical solution and/or application scenario description that is not described in detail later, please refer to the previous related detailed description.

In this application, the descriptions of various embodiments have different focuses. For parts that are not described or recorded in a certain embodiment, please refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to be within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A paging transmission method, comprising following steps:
S2: selecting or determining a paging frame and/or a paging occasion for paging based on paging configuration information and/or a preset formula; and
S3: receiving the paging according to the paging frame and/or the paging occasion.

2. The method according to claim 1, wherein at least one of the following is comprised:
the paging configuration information comprises at least one of the following: a default paging cycle, a paging frame offset, a number of first paging frames in the paging cycle, a number of first paging occasions contained in each paging frame, a paging compact cycle and a number of paging frames in the paging compact cycle; and
the preset formula comprises a first preset formula and/or a second preset formula.

3. The method according to claim 2, wherein the selecting or determining the paging frame and/or the paging occasion of each paging according to the paging configuration information and/or the second preset formula comprises at least one of the following:
selecting or determining the radio frame where the paging frame in the paging compact cycle is located according to the second preset formula, and selecting or determining a slot or a symbol of each paging occasion in each paging frame.

4. The method according to claim 3, wherein the radio frame, the slot or the symbol where each paging occasion is located is associated with a configuration of a paging search space.

5. The method according to claim 3, further comprising at least one of the following:
a number of paging occasions contained in each paging frame in the paging compact cycle being greater than or equal to the number of first paging occasions contained in each paging frame; and
a number of paging frames in the paging compact cycle being less than or equal to the number of first paging frames in the paging cycle.

6. The method according to claim 3, further comprising at least one of the following:
a unit of the paging compact cycle being a number of radio frames; and
the second preset formula being (SFN1+delta_f) mod ES duration=((ES duration) div N1)*(UE_ID mod N1), wherein delta_f is configured by a system information or a radio resource control parameter, ES duration is the paging compact cycle, N1 is the number of paging frames in the paging compact cycle, UE_ID is a UE identity, and SFN1 is the radio frame where the paging frame in the paging compact cycle is located.

7. A paging transmission method, comprising following steps:
S1: sending paging configuration information to make a terminal select or determine a paging frame and/or a paging occasion where paging is located based on the paging configuration information and/or a preset formula, and receive the paging according to the paging frame and/or paging occasion.

8. The method according to claim 7, wherein at least one of the following is comprised:
the paging configuration information comprises at least one of the following: a default paging cycle, a paging frame offset, a number of first paging frames in a paging cycle, a number of first paging occasions contained in each paging frame, a paging compact cycle and a number of paging frames in a paging compact cycle; and
the preset formula comprises a first preset formula and/or a second preset formula.

9. The method according to claim 8, wherein the selecting or determining the paging frame and/or the paging occasion of each paging according to the paging configuration information and/or the second preset formula comprises:
selecting or determining, via the terminal, the radio frame where the paging frame in the paging compact cycle is located according to the second preset formula, and selecting or determining a slot or a symbol of each paging occasion in each paging frame.

10. The method according to claim 9, wherein the radio frame, the slot or the symbol of each paging occasion in the paging compact cycle is associated with a configuration of a paging search space.

11. The method according to claim 9, further comprising at least one of the following:
a number of paging occasions contained in each paging frame in the paging compact cycle being greater than or equal to the number of first paging occasions contained in each paging frame; and
a number of paging frames in the paging compact cycle being less than or equal to the number of first paging frames in the paging cycle.

12. The method according to claim 9, further comprising at least one of the following:
the paging compact cycle being smaller than the paging cycle;
a unit of the paging compact cycle being a number of radio frames;
the second preset formula being (SFN1+delta_f) mod ES duration=((ES duration) div N1)*(UE_ID mod N1), wherein delta_f is semi-statically configured by a system information or a radio resource control parameter, ES duration is the paging compact cycle, N1 is the number of paging frames in the paging compact cycle, UE_ID is a UE identity, and SFN1 is the radio frame where the paging frame in the paging compact cycle is located.

13. A communication device, comprising: a memory, a processor, and a paging transmission program stored in the memory and executable on the processor, wherein the paging transmission program implements the steps of the paging transmission method according to claim 1 when executed by the processor.

14. A communication device, comprising: a memory, a processor, and a paging transmission program stored in the memory and executable on the processor, wherein the paging transmission program implements the steps of the paging transmission method according to claim 7 when executed by the processor.

15. A non-transitory computer-readable storage medium, wherein a computer program is stored on the storage medium, the computer program implements the steps of the paging transmission method according to claim 1 when executed by a processor.

16. A non-transitory computer-readable storage medium, wherein a computer program is stored on the storage medium, the computer program implements the steps of the paging transmission method according to claim 7 when executed by a processor.
